(19) United States
(12) Patent Application Publication
(10) Pub. No.: US 2024/0207932 A1
(43) Pub. Date: Jun. 27, 2024

(54) Gas atomizer

(71) Applicant: ArcelorMittal, Luxembourg (LU)

(72) Inventor: Benjamin BOISSIERE, Metz (FR)

(21) Appl. No.: 18/288,300

(22) PCT Filed: Apr. 26, 2022
(86) PCT No.: PCT/IB2022/053843

§ 371 Date: Oct. 25, 2023

(30) Foreign Application Priority Data
Apr. 28, 2021 (WO) PCT/IB2021/053518

(51) Int. Cl. B22F 9/08

(52) U.S. Cl. CPC B22F 9/082; B22F 2009/0848; B22F 2009/0876; B22F 2301/35; B22F 2998/10

(57) ABSTRACT

A process for manufacturing metal powders, including (i) feeding a chamber of a gas atomizer with molten metal, (ii) atomizing the molten metal by injection of gas so as to form metal particles, (iii) cooling the metal particles in the lower section of the chamber by injecting gas from the bottom of the chamber so as to form a bubbling fluidized bed of metal particles. The gas atomizer thereof is also provided.

The present invention relates to a gas atomizer for the production of metal powders and in particular for the production of steel powders for additive manufacturing. The present invention also relates to the method for manufacturing metal powders by gas atomization.

### BACKGROUND

There is an increasing demand for metal powders for additive manufacturing and the manufacturing processes have to be adapted consequently.

### SUMMARY OF THE INVENTION

It is notably known to melt metal material and to pour the molten metal in a tundish connected to an atomizer. The molten metal is forced through a nozzle in a chamber under controlled atmosphere and impinged by jets of gas which atomize it into fine metal droplets. The latter solidify into fine particles which fall at the bottom of the chamber and accumulate there until the molten metal has been fully atomized. The powder is then let to cool in the atomizer until it reaches a temperature where it can be in contact with air without oxidizing too quickly. The atomizer is then opened to collect the powder. Such a cooling is a long process which is not compatible with the need for producing large amounts of metal powders.

An aim of the present invention is therefore to remedy the drawbacks of the facilities and processes of the prior art by providing a gas atomizer wherein the obtained powder can be rapidly cooled in the atomizer chamber.

Also, the process according to the prior art described above is a batch process which is not compatible with the need for producing large amounts of metal powders in a continuous mode.

An additional or alternative aim of the present invention is to provide a gas atomizer wherein the obtained powder can be discharged from the atomizer chamber without disrupting the atomization.

For this purpose, a first subject of the present invention consists of a process for manufacturing metal powders, comprising:
(i) feeding a chamber of a gas atomizer with molten metal,
(ii) atomizing the molten metal by injection of gas so as to form metal particles,
(iii) cooling the metal particles in the lower section of the chamber by injecting gas from the bottom of the chamber so as to form a bubbling fluidized bed of metal particles.

The process according to the invention may also have the optional features listed below, considered individually or in combination:
the molten metal is steel obtained through a blast furnace route,
the molten metal is steel obtained through an electric arc furnace route,
steps (ii) and (iii) are done simultaneously,
in step (iii), the metal particles are cooled below 300° C.,
in step (iii), the injected gas is extracted, cooled down and re-injected,
the gas is cooled down below 50° C.,
the process further comprises the step (iv) of continuously discharging metal particles from the chamber,
the continuous discharge is done through an overflow,
the process further comprises the step (v) of transporting the discharged metal particles to a sieving station,
the discharged metal particles are transported in the form of a fluidized bed.

A second subject of the invention consists of a gas atomizer comprising a chamber, gas injectors positioned at the bottom of the chamber and a flow regulator coupled to the gas injectors for fluidizing the metal particles to be accumulated in the lower section of the chamber and forming a bubbling fluidized bed of metal particles.

The gas atomizer according to the invention may also have the optional features listed below, considered individually or in combination:
the gas injectors comprise openings in the bottom wall of the chamber,
the distance between the bottom of the chamber and the gas injectors is preferably shorter than 10 cm,
the gas injectors are spargers,
the gas atomizer further comprises a heat exchanger positioned in the lower section of the chamber,
the gas atomizer further comprises an overflow in the lower section of the chamber,
the overflow is a pipe at least partially extending in the lower section of the chamber and passing through the bottom wall of the chamber,
the portion of the overflow outside the chamber comprises a gas inlet,
the gas atomizer further comprises a coarse particles collector at the bottom of the chamber,
the gas atomizer further comprises a gas extractor in the upper section of the chamber,
the gas extractor comprises a cyclone separator for dedusting the gas extracted from the chamber,
the gas extractor is connected to the gas injectors for gas recirculation within the atomizer
the connection between the gas extractor and the gas injectors comprises a heat exchanger.

A third subject of the invention consists of an installation comprising a gas atomizer according to the invention and a conveyor comprising a lower duct for the circulation of gas, an upper duct for the circulation of powder material and a porous wall separating the lower and upper ducts over substantially their entire length.

The installation according to the invention may optionally comprise a conveyor comprising a fluidization gas inlet and a flow regulator coupled to the gas inlet for fluidizing the metal particles to be discharged from the gas atomizer and forming a fluidized bed of metal particles in the upper duct.

As it is apparent, the invention is based on the recourse to the technology of fluidized beds for efficiently cooling the powder which accumulates at the bottom of the atomizer chamber. In the case where an overflow is added at the lower section of the atomizer, the fluidized powder can be continuously discharged from the atomizer without disrupting the atomization process.

Other characteristics and advantages of the invention will be described in greater detail in the following description.

### BRIEF DESCRIPTION OF THE DRAWINGS

The invention will be better understood by reading the following description, which is provided purely for purposes of explanation and is in no way intended to be restrictive, with reference to:

FIG. 1, which illustrates a gas atomizer according to a variant of the invention,

FIG. 2 which illustrates possible regimes of fluidization,

FIG. 3 which illustrates an installation comprising two atomizers and a conveyor according to first variant of the invention,

FIG. 4 which illustrates an installation comprising two atomizers and a conveyor according to second variant of the invention.

### DETAILED DESCRIPTION

It should be noted that the terms “lower”, “beneath”, “inward”, “inwards”, “outward”, “outwards”, “upstream”, “downstream”, . . . as used in this application refer to the positions and orientations of the different constituent elements of the device when the latter is installed in a plant.

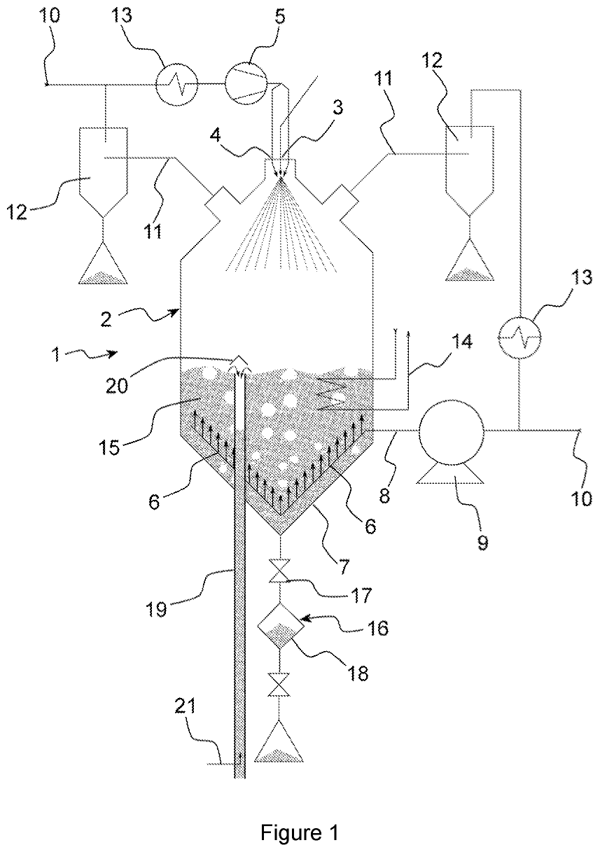

With reference to FIG. 1, a gas atomizer 1 is a device designed for atomizing a stream of liquid metal into fine metal droplets by impinging the stream with a high velocity gas stream. The gas atomizer 1 is mainly composed of a closed chamber 2 maintained under protective atmosphere. The chamber has an upper section, a lower section, a top and a bottom.

The upper section of the chamber comprises an orifice, the nozzle 3, usually positioned at the center of the chamber top, through which the molten metal stream is forced. The nozzle is surrounded by a gas sprayer 4 for jetting a gas at high speed on the stream of liquid metal. The gas sprayer is preferably an annular slot through which pressurized gas flows. The gas sprayer is preferably coupled to a gas regulator 5 to control the flow and/or the pressure of the gas before jetting it. The gas regulator can be a compressor, a fan, a pump, a pipe section reduction or any suitable equipment.

The lower section of the chamber is mainly a receptacle for collecting the metal particles falling from the upper section of the chamber. It is usually designed to facilitate the powder collection and powder discharge through a discharge opening positioned at the bottom of the chamber. It is thus usually in the form of an inverted cone or an inverted frustoconical shape.

The gas atomizer comprises gas injectors 6, positioned at the bottom of the chamber, capable of fluidizing the metal particles to be accumulated in the lower section of the chamber and capable of creating a bubbling fluidized bed of metal particles. Thanks to this fluidized bed, the metal particles are efficiently cooled down below their oxidation window by intense gas-to-particle heat transfer. The metal particles accumulated in the lower section of the chamber are kept cool and the hot particles falling from the chamber top are very rapidly mixed in the fluidized bed and cooled. Furthermore, as the cooling is done directly inside the chamber, which is maintained under protective atmosphere, the metal particles do not oxidize during their cooling.

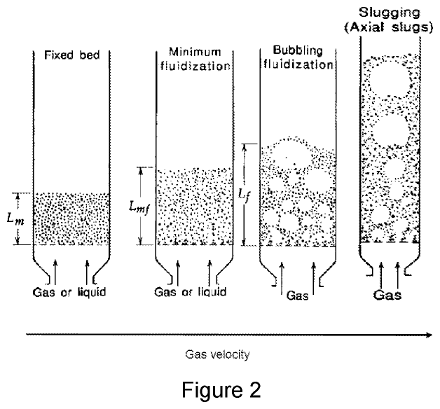

As illustrated in FIG. 2, there are several regimes of fluidization. Fluidization is the operation by which solid particles are transformed into a fluidlike state through suspension in a gas or a liquid. Depending on the fluid velocity, behavior of the particles is different. In gas-solid systems as the one of the invention, as the flow velocity increases, the bed of particles goes from a fixed bed to minimum fluidization, to bubbling fluidization and to slugging where agitation becomes more violent and the movement of solids become more vigorous. In particular, with an increase in flow velocity beyond minimum fluidization, instabilities with bubbling and channeling of gases are observed. At this stage, the fluidized bed is in a bubbling regime, which is the required regime for the invention in order to have a good circulation of the solid particles within the bed, a rapid cooling and a homogeneous temperature of the fluidized bed. Gas velocity to be applied to get a given regime and the desired temperature of the fluidized bed depends on several parameters like the kind of gas used, the size and density of the particles, the gas pressure drop offered by the gas injectors or the size of the chamber. This can be easily managed by a person skilled in the art. In addition, in the bubbling regime, the bed does not expand much beyond the solid volume which helps keeping installations at reasonable sizes. The concept of bubbling fluidized bed is defined in “Fluidization Engineering” by Daizo Kunii and Octave Levenspiel, second edition, 1991, notably in pages 1 and 2 of the Introduction.

Thanks to the bubbling fluidized bed, and contrary to other regimes of fluidized beds, the metal particles are very rapidly and very efficiently cooled down to the working temperature of the fluidized bed while maintaining a homogeneous distribution of the particle sizes within the bed. Consequently, there is no need to use powdery coolants to help the metal particles to cool.

In the context of the invention, “positioned at the bottom of the chamber” means that the gas injectors 6 are positioned sufficiently close to the bottom 7 of the chamber, in the lower section of the chamber, so that substantially all the particles formed in the atomizer are fluidized. Solidified splashes resulting from the initial non-atomized metal stream and/or coarse particles may not be fluidized and may drop below the gas injectors, i.e. below the fluidized bed. The distance between the bottom of the chamber and the gas injectors is preferably shorter than 10 cm, more preferably shorter than 4 com, even more preferably between 1 and 3 cm.

The gas injectors 6 inject gas from the bottom of the chamber toward the top of the chamber so that the particles at the bottom of the chamber are lifted up and the fluidized bed is formed.

The gas injectors can comprise openings in the bottom wall of the chamber. Gas can be injected through these openings to fluidize the powder bed.

The gas injectors can comprise pipes 8 passing through the side wall of the chamber. The portion of the gas injectors positioned inside the chamber can follow the shape of the bottom wall at a close distance, as shown in the example illustrated in FIG. 1.

The gas injectors can comprise porous metal plates, sintered metal plates or canvas. The gas injectors preferably comprise spargers, which are parts, such as pipes, pierced with many small holes to provide dispersion of the injected gas. Spargers are preferred for gas velocities above 10 cm/s as they offer a sufficient pressure loss. The spargers are more preferably porous spargers. This type of spargers ensures the distribution of gas in the bed of metal particles by thousands of tiny pores.

Each sparger can comprise a grommet seal (compression fitting) which allows the sparger to be inserted and removed from the atomizer while the atomizer is in operation.

The gas injectors are coupled to a flow regulator 9. The latter controls the flow of gas injected through the gas injectors and thus the velocity of the gas in the chamber since the section of the chamber is known. The gas flow can thus be adjusted so that the metal particles are fluidized and the obtained fluidized bed is maintained in a bubbling regime. The gas regulator can be in the form of a fan. The fan speed is adjusted to control the flow of gas injected through the gas injectors. The flow regulator is connected to a gas source. The gas source can be a gas inlet 10 designed to let fresh gas in and/or a gas extractor providing recirculated gas as described below.

The gas atomizer 1 preferably comprises a gas extractor 11 to compensate for the gas injection through the gas injectors 6 and the gas sprayer 4. The gas extractor is preferably located in the upper section of the chamber so that it doesn't interfere with the fluidized bed and/or so that particles above the fluidized bed because of bubble splashing fall back in the bed by gravity before reaching high gas velocity regions which would entrain it in the gas extractor. The gas extractor can be in the form of one pipe or a plurality of pipes connected on one side to the chamber and on the other side to dedusting means 12. The dedusting means remove the finest particles from the extracted gas. They can comprise an electro-filter, a bag filter or a cyclone separator. Cyclone separator is preferred because it has relatively low pressure drops and it has no moving parts.

Preferably the gas extractor 11 is designed so that the gas injected in the chamber and extracted through the gas extractor can be recirculated. Consequently, the gas consumption is minimized. Accordingly, the gas extractor is preferably connected to the gas injectors 6, to the gas sprayer 4 or to both. In particular, the dedusting means 12 connected on one side to the chamber are connected on the other side to the gas regulator 5 coupled to the gas sprayer 4, or to the flow regulator 9 coupled to the gas injectors 6 or to both.

On the example illustrated on FIG. 1, one dedusting means 12, in the form of a cyclone separator, is connected to the gas regulator 5 for jetting the gas on the metal stream so that the gas injected in the chamber to atomize the metal is recirculated. Another dedusting means 12, in the form of a cyclone separator, is connected to the gas regulator 5 for injecting gas at the bottom of the chamber so that the gas used for fluidizing the powder bed is recirculated. In both cases, filters can be added to clean the gas to be recirculated. Other designs of the gas recirculation are of course possible.

The connection between the gas extractor 11 and the gas injectors 6 preferably comprises a heat exchanger 13. Consequently, the gas can be cooled to the temperature at which it has to be injected in the chamber in case the heat losses in the connection are not enough to bring the gas back to the desired temperature and/or if heat recovery is desired.

The connection between the gas extractor 11 and the gas injectors 6 may also comprise a gas inlet 10 in case some fresh gas has to be introduced in the system, notably to compensate gas losses.

The connection between the gas extractor 11 and the gas sprayer 4 preferably comprises a heat exchanger 13. Consequently, the gas can be cooled to the temperature at which it has to be jetted on the molten metal stream in case the heat losses in the connection are not enough to bring the gas back to the desired temperature and/or if heat recovery is desired.

The connection between the gas extractor 11 and the gas sprayer 4 may also comprise a gas inlet 10 in case some fresh gas has to be introduced in the system, notably to compensate gas losses.

According to one variant of the invention, the gas atomizer further comprises a heat exchanger 14 positioned in the lower section of the chamber. It is positioned so that the bubbling fluidized bed 15 formed with the chamber is in contact with the heat exchanger. The heat exchanger can be positioned at least partially within the chamber or it can be a cooling jacket around the lower section of the chamber. The solid particles kept in motion by the injection of gas through the gas injectors 6 come in contact with the heat exchanger where they release the captured heat to the transfer medium circulating within. The flow rate of medium inside the heat exchanger can be regulated to control the cooling rate. Such a heat exchanger facilitates the cooling of the particles in the fluidized bed and their holding at the desired temperature. The heat exchanger can also decrease the flow of gas needed to cool or maintain the particles at the desired temperature.

According to one variant of the invention, the gas atomizer 1 further comprises a coarse particle collector 16 below the bottom of the chamber. As indicated above, solidified splashes resulting from the initial non-atomized metal stream and/or coarse particles may not be fluidized and may drop below the gas injectors, i.e. below the fluidized bed, at the bottom of the chamber. The coarse particle collector allows for the discharge of these undesired particles from the atomizer without disrupting the atomization. The coarse particle collector preferably comprises a valve 17 and a collection chamber 18. The collection chamber can be connected to a movable chamber through a second valve. This way the movable chamber can be replaced without compromising the pressure in the chamber.

According to one variant of the invention, once the metal particles have been produced and cooled by the fluidized bed, they are discharged through a discharge opening positioned at the bottom of the chamber. It can be done once a batch of molten metal has been atomized or without disrupting the atomization depending on the technology of the discharge opening.

According to another variant of the invention, the gas atomizer comprises an overflow 19 in the lower section of the chamber. Its purpose is to discharge the powder from the chamber 2. In particular, the fluidized powder in the lower section of the chamber can be discharged from the gas atomizer in a continuous mode as soon as the level of the fluidized bed reaches the top of the overflow 19. The atomizer can thus be run continuously.

The overflow 19 preferably extends at least partially in the lower section of the chamber and passes through the bottom wall 7 of the chamber. It can be in the form of a downcomer. It is more preferably a pipe. Its section is preferably adapted to the powder flow to be discharged from the chamber. In particular, its section is adapted to the molten metal flow leaving the nozzle so that there is no accumulation of powder in the lower section of the chamber over time. In the case where the coarser particles formed in the atomizer would be collected at the bottom of the chamber, the section of the overflow is preferably adapted to the molten metal flow leaving the nozzle, coarser particles set aside. The section of the pipe is preferably constant, i.e. without reductions along the pipe or at its upper extremity, to favor a homogeneous discharge of the metal powder and avoid clogging. In one variant of the invention, the overflow, or the pipe if applicable, comprises a valve for adjusting the powder flow to be discharged from the chamber. In one variant of the invention, the lower extremity of the overflow has a reduced section to further limit the flow of gas from the outside of the atomizer to the inside.

The height of the overflow is defined as the vertical distance between the top of the overflow and the bottom of the chamber, i.e. as the vertical length of the portion of the overflow extending in the chamber. The height of the overflow is preferably set so that the volume of fluidized bed is large enough to cool the metal powder at the desired temperature. The volume of the fluidized bed is indeed defined substantially by the section of the lower section of the chamber and the height of the overflow. If the overflow height is short, the volume of fluidized bed is low and the residence time of the particles in the fluidized bed is short. Consequently, the discharged particles are still hot. If the overflow height is very long, the volume of fluidized bed is high and the residence time of the particles in the fluidized bed is long. Consequently, the discharged particles are cold. Based on these principles, the person skilled in the art can select the height of the overflow depending on the dimensions of the chamber and the desired temperature of the discharged particles. In one variant of the invention, the overflow, or the pipe if applicable, comprises height adjustment means so that the height of the overflow can be adjusted on the fly, notably to adjust the cooling of the powder and consequently the temperature of the powder discharged from the chamber.

Thanks to the overflow, the residence time of the particles in the fluidized bed is homogeneous whatever the size of the particles, contrary to other solutions, like valves or pipes at the bottom of the chamber, for which coarser particles would be discharged first and before having been cooled to the working temperature of the fluidized bed. Moreover, as the quantity of gas exiting the chamber through the overflow is low, the major part of the injected gas is used to fluidize the bed, which contributes to a very stable fluidized bed. In addition, the overflow is not a mechanical part which limits its wear by the particles.

According to one variant of the invention, the overflow 19 is overhung by a hat 20. Consequently, hot metal powder falling from the upper section of the chamber is prevented from directly entering the overflow. The hat is positioned high enough above the top of the overflow so that it doesn't disturb the powder flow discharged through the overflow. The hat and the top of the overflow can be positioned substantially vertical to the nozzle 3 and the hat can comprise an impact pad. In that configuration, the stream of molten metal which is not atomized at the start of the atomization process impacts the impact pad and is dispersed into small particles which are not detrimental to the process.

According to one variant of the invention, the overflow 19, and preferably the portion of the overflow outside the chamber, further comprises a gas inlet 21. Consequently, gas, and preferably the one used for fluidizing the powder inside the chamber, can be injected in the overflow. This helps to keep the discharge powder in a fluidized form and prevents the atmosphere downstream of the overflow from entering the chamber.

The powder discharged from the chamber through the overflow can be collected in a chamber, a container or by a conveyor 22. The conveyor is part of the installation comprising the gas atomizer 1. Preferably, it transports the powder to a sieving station 23 and/or to a bagging station. The conveyor can notably be a vacuum pneumatic conveyor, a pressure conveyor or a suction-pressure conveyor.

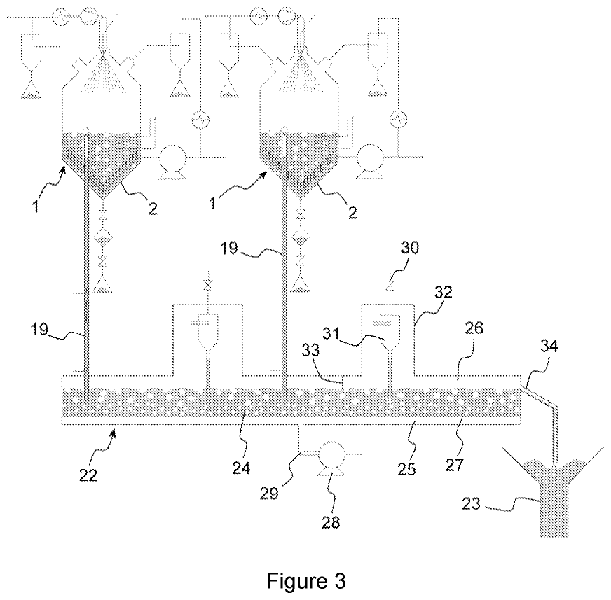

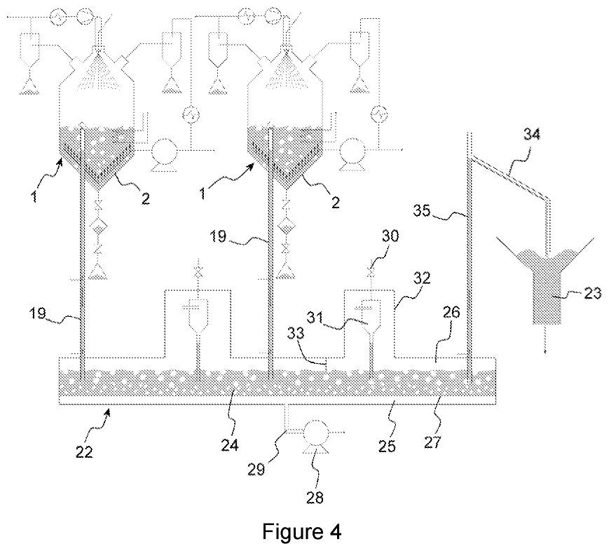

According to one variant of the invention illustrated on FIGS. 3 and 4, the powder discharged from the chamber 2 is transported in the form of a fluidized bed 24, preferably a bubbling fluidized bed. This kind of transport is advantageous since it requires minimum ventilation power, dust emissions can be prevented and continuous operation can be ensured.

The conveyor 22 preferably comprises a lower duct 25 for the circulation of a fluidization gas, an upper duct 26 for the circulation of the powder and a porous wall 27 separating the lower and upper ducts over substantially their entire length.

The porous wall lets the fluidization gas go through it. Such porous wall is designed so that there is a sufficient pressure drop of the gas as it passes through the porous wall to ensure the homogeneous distribution of the gas over the entire cross-section of the upper duct. The porous wall can be a multi-ply canvas fabric or a porous refractory.

The lower duct is supplied with fluidization gas by means of a fluidization gas inlet 29 coupled to a flow regulator 28. The fluidization gas inlet can be in the form of a fluidization gas inlet conduit and the flow regulator can be in the form of a fan. The flow regulator controls the flow of gas injected in the lower duct and thus the velocity of the gas in the upper duct since the surface of the porous wall is known. The gas flow can thus be adjusted so that the metal particles in the upper duct are fluidized. When the flow regulator is a fan, its speed is adjusted to control the flow of fluidization gas injected in the lower duct. The flow regulator is connected to a gas source. The gas source can be a gas inlet designed to let fresh gas in and/or a conduit providing recirculated gas.

Thanks to this homogeneous distribution of the gas over the entire cross-section of the upper duct, only one flow regulator 28 can be used for the whole conveyor. This simplifies the installation and the maintenance.

The conveyor 22 comprises, at the top of the upper duct 26, at least one pressure valve 30 so that the pressure in fluidization gas in the upper duct can be regulated. The pressure valve is preferably connected to the upper duct through a cyclone 31 positioned in cyclone box 32. That way, the fluidization gas exiting the upper duct through the pressure valve is filtrated, i.e. the particles of the bed dragged by the flow of fluidization gas are separated from the gas and fall back in the fluidized bed. The cyclone box is preferably positioned above the level of the upper duct top to minimize the dragging of the particles in the cyclone.

Preferably, the conveyor 22 comprises a plurality of pressure valves 30 distributed along the length of the upper duct. This limits the horizontal circulation of the fluidization gas above the fluidized bed and thus further stabilizes the fluidized bed. More preferably, the plurality of pressure valves is combined with gas dams 33. Each dam is positioned transversally in the upper portion of the upper duct and in-between two consecutive pressure valves 30. These gas dams further limit the horizontal circulation of the fluidization gas above the fluidized bed.

The conveyor 22 comprises, at one of its extremity, a conveyor overflow 34 for discharging the powder in the sieving station 23 and/or in the bagging station. The conveyor overflow can be provided in the end section of the upper duct as illustrated on FIG. 3. In that case, as soon as the level of the fluidized bed reaches the level of the conveyor overflow, the powder flows in the sieving station and/or in the bagging station. The conveyor overflow can also be positioned above the extremity of the conveyor as illustrated on FIG. 4. In that case, it is connected to the upper duct through an upward pipe 35. The way the powder is discharged from the conveyor in that case is described later on. This configuration is very convenient to feed a sieving station and/or a bagging station which may not be fully positioned below the conveyor.

The conveyor 22 is connected, preferably at its other extremity, to the overflow 19 of the atomizer. In particular, the overflow lower end is connected to the upper duct 26. The conveyor can be connected to a plurality of overflows and thus to a plurality of atomizers. In that case, the overflows are distributed along the entire length of the conveyor. In case there is a plurality of pressure valves, they are preferably positioned in-between the overflows and the potential gas dam are preferably positioned adjacent to and upstream of an overflow.

The conveyor 22 is preferably a closed device communicating with the outside only by the overflow of the atomizer and the conveyor overflow as far as the powder is concerned, and only by the inlet conduit, preferably single, and the pressure valves as far as the fluidization gas is concerned.

The conveyor 22 is preferably horizontal. It can also be made of different portions. These portions can be at different levels. The transport can thus be easily adapted to the topography of the site.

To operate the conveyor 22, the fluidization gas is introduced at a given flow rate below the porous wall 27 which separates the lower duct 25 and the upper duct 26 of the conveyor.

The fluidization gas flows through the porous wall and then passes between the particles laying in the upper duct and forming the layer to be fluidized. As soon as the speed of fluidization gas in the interstitial space existing between the particles is sufficiently high, the particles are mobilized and then lifted, each particle losing its points of permanent contact with the neighbouring particles. That way, a fluidized bed 24 is formed in the upper duct.

The powder discharged from the chamber 2 through the overflow 19 in the upper duct 26 is kept in a fluidized form in the conveyor. As it behaves like a fluid, it remains level in the upper duct and a continuous flow of powder is created along the conveyor by discharging the fluidized bed at the conveyor overflow 34 from the conveyor to the sieving station and/or to the bagging station. In the case where the conveyor overflow is provided in the end section of the upper duct, the continuous flow is obtained as soon as the level of the fluidized bed reaches the level of the conveyor overflow. In the case where the conveyor overflow is connected to the upper duct by an upward pipe 35, the pressure in fluidization gas in the upper duct is set slightly above the atmospheric pressure so that the fluidized bed goes up in the upward pipe, up to the conveyor overflow. For example, in the case of steel particles, the over-pressure relatively to the atmospheric pressure can be set between 200 and 600 mbar per meter of upward pipe.

In case the supply in powder through the atomizer overflow is discontinued, the level of the fluidized bed will decrease in the conveyor until it reaches the level of the conveyor overflow. At this point, the flow through the conveyor overflow stops. Inversely, if for some reason the conveyor overflow has to be temporarily closed, the level of the fluidized bed will increase in the conveyor. In that case, the supply in powder through the atomizer overflow may have to be discontinued only if the level of the fluidized bed reaches the top of the upper duct.

In addition, the powder transport with this conveyor can be turned on and off very easily. The inlet in fluidization gas has just to be turned on and off.

The fluidization gas can be air if the powder has been cooled enough and will not oxidize in contact with air. If there is a need to protect the powder from the atmosphere, the fluidization can be an inert gas, like argon or nitrogen. In that case, the inert gas is preferably recirculated.

From a process perspective, the cooling of powder inside the atomizer chamber 2 is made possible thanks to a process for manufacturing metal powders comprising:
(i) feeding a chamber 2 of a gas atomizer 1 with molten metal,
(ii) atomizing the molten metal by injection of gas so as to form metal particles,
(iii) cooling the metal particles in the lower section of the chamber by injecting gas from the bottom of the chamber so as to form a bubbling fluidized bed 15 of metal particles.

Preferably, this process is for continuously manufacturing metal powders, as it will be described in greater details below.

The metal to be atomized can be notably steel, aluminum, copper, nickel, zinc, iron, alloys. Steel includes notably carbon steels, alloyed steels and stainless steels.

The metal can be provided to the atomizer in solid state and melted in a tundish connected to the atomizer through the nozzle. It can also be melted at a previous step and poured in the tundish.

According to one variant of the invention, the molten metal to be atomized is steel obtained through a blast furnace route. In that case, pig iron is tapped from a blast furnace and transported to a converter (or BOF for Basic Oxygen Furnace), optionally after having been sent to a hot metal desulfurization station. The molten iron is refined in the converter to form molten steel. The molten steel from the converter is then tapped from the converter to a recuperation ladle and preferably transferred to a ladle metallurgy furnace (LMF). The molten steel can thus be refined in the LMF notably through de-oxidation and a primary alloying of the molten steel can be done by adding ferroalloys or silicide alloys or nitride alloys or pure metals or a mixture thereof. In certain cases where demanding powder compositions have to be produced, the molten steel can be also treated in a vacuum tank degasser (VTD), in a vacuum oxygen decarburization (VOD) vessel or in a vacuum arc degasser (VAD). These equipment allow for further limiting notably the hydrogen, nitrogen, sulphur and/or carbon contents.

The refined molten steel is then poured in a plurality of induction furnaces. Each induction furnace can be operated independently of the other induction furnaces. It can notably be shut down for maintenance or repair while the other induction furnaces are still running. It can also be fed with ferroalloys, scrap, Direct Reduced Iron (DRI), silicide alloys, nitride alloys or pure elements in quantities which differ from one induction furnace to the others.

The number of induction furnaces is adapted to the flow of molten steel coming from the converter or refined molten steel coming from the ladle metallurgy furnace and/or to the desired flow of steel powder at the bottom of the atomizers.

In each induction furnace, alloying of the molten steel is be done by adding ferroalloys or silicide alloys or nitride alloys or pure metals or a mixture thereof to adjust the steel composition to the composition of the desired steel powder.

Then, for each induction furnace, the molten steel at the desired composition is poured in a dedicated reservoir connected to at least one gas atomizer. By “dedicated” it is meant that the reservoir is paired with a given induction furnace. That said, a plurality of reservoirs can be dedicated to one given induction furnace. For the sake of clarity, each induction furnace has its own production stream with at least one reservoir connected to at least one gas atomizer. With such parallel and independent production streams, the process for producing the steel powders is versatile and can be easily made continuous.

The reservoir is mainly a storage tank capable of being atmospherically controlled, capable of heating the molten steel and capable of being pressurized.

The atmosphere in each of the dedicated reservoirs is preferably Argon, Nitrogen or a mixture thereof to avoid the oxidation of the molten steel.

The steel composition poured in each reservoir is heated above its liquidus temperature and maintain at this temperature Thanks to this overheating, the clogging of the atomizer nozzle 3 is prevented. Also, the decrease in viscosity of the melted composition helps obtaining a powder with a high sphericity without satellites, with a proper particle size distribution.

Finally, when a dedicated reservoir is pressurized, the molten steel can flow from the reservoir to at least one of the gas atomizers connected to the reservoir.

According to another variant of the invention, the metal to be atomized is steel obtained through an electric arc furnace route. In that case, raw materials such as scraps, metal minerals and/or metal powders are fed into an electric arc furnace (EAF) and melted into heated liquid metal at a controlled temperature with impurities and inclusions removed as a separate liquid slag layer. The heated liquid metal is removed from the EAF into a ladle, preferably into a passively heatable ladle and moved to a refining station where it is preferably placed in an inductively heated refining holding vessel. There, a refining step, such as a vacuum oxygen decarburization is performed to remove carbon, hydrogen, oxygen, nitrogen and other undesirable impurities from the liquid metal. The ladle with the refined liquid metal can then be transferred above a closed chamber under controlled vacuum and inert atmosphere and containing the heated tundish of an atomizer. The ladle is connected to a feeding conduit and the heated tundish is then fed in refined liquid metal through the feeding conduit.

Alternatively, the ladle with the refined liquid metal is transferred from the refining station to another inductively heated atomizing holder vessel located at the door of an atomizer station containing a pouring area under controlled vacuum and inert atmosphere with the heated tundish of a gas atomizer. The inductively heated atomizing holder vessel is then introduced into a receiving area where the vacuum and atmosphere are adjusted to the one of the pouring area. Then, the vessel is introduced into the pouring area and the liquid metal is poured into the heated tundish at a controlled rate and atomized with the atomizer.

In both variants, the molten metal is maintained at the atomization temperature in the tundish until it is forced through the nozzle 3 in the chamber 2 under controlled atmosphere (step (i)) and impinged by jets of gas which atomize it into fine metal droplets (step (ii)).

For step (ii), the gas injected through the gas sprayer 4 to atomize the metal stream is preferably argon or nitrogen. They both increase the melt viscosity slower than other gases, e.g. helium, which promotes the formation of smaller particle sizes. They also control the purity of the chemistry, avoiding undesired impurities, and play a role in the good morphology of the powder. Finer particles can be obtained with argon than with nitrogen since the molar weight of nitrogen is 14.01 g/mole compared with 39.95 g/mole for argon. On the other hand, the specific heat capacity of nitrogen is 1.04 J/(g K) compared to 0.52 for argon. So, nitrogen increases the cooling rate of the particles.

The gas flow impacts the particle size distribution and the microstructure of the metal powder. In particular, the higher the flow, the higher the cooling rate. Consequently, the gas to metal ratio, defined as the ratio between the gas flow rate (in m³/h) and the metal flow rate (in Kg/h), is preferably kept between 1 and 5, more preferably between 1.5 and 3.

Once metal particles have been obtained from the atomization of molten metal in the chamber, the obtained powder is cooled down in the lower section of the chamber by injecting gas from the bottom of the chamber so as to form a bubbling fluidized bed 15 of metal particles (step (iii)). This step is preferably done simultaneously with the atomization step. It is more preferably done continuously and simultaneously with the atomization step. This way the atomizer can work continuously.

During this step, the metal particles are preferably cooled down below their oxidation window. In the case of steel powder, the metal particles are preferably cooled below 300° C., more preferably below 260° C., even more preferably between 150 and 260° C. With such a cooling, the powder can then be manipulated in the air at the next steps of the process. Depending on the sensitivity of the steel composition to oxidation and/or the purity of the gas, the cooling can be adjusted. The powder is preferably not cooled too much, e.g. below 150° C., to limit the gas flow needed to cool the powder. In a continuous mode, the gas flow is adjusted so that the fluidized bed is maintained at a constant temperature while a part of the particles is continuously discharged from the chamber and new hot particles are continuously added to the bed. In that case, the fluidized bed is maintained below 300° C., more preferably below 260° C., even more preferably between 150 and 260° C.

The gas injected through the gas injectors 6 to fluidize the powder bed is preferably argon or nitrogen, and more preferably the same gas as the one used to atomize the molten metal stream. It is preferably injected at a velocity between 1 and 80 cm/s which requires a low ventilation power and so a reduced energy consumption. The gas flow is preferably regulated by the flow regulator 9, such as a fan.

The gas is preferably injected at a temperature comprised between 10 and 50° C. This further improves the cooling of the metal particles.

The injected gas is preferably extracted from the chamber to maintain a constant pressure in the chamber. The gas flow in the gas extractor 11 is adjusted accordingly. The pressure in the chamber 2 is preferably set between 5 and 100 mbars.

The injected gas is preferably recirculated. In that case, it is more preferably cooled down after being extracted from the chamber. It is preferably cooled down below 50° C., more preferably between 10 and 50° C.

During step (iii), the cooling of the metal particles can be further enhanced by contacting the fluidized bed with a heat exchanger 14.

The process according to the invention can further comprise a step (iv) of continuously discharging cooled metal particles from the chamber. This step is preferably done simultaneously with the atomization step and with the cooling step. The continuous discharge can be done through an overflow 19, as described earlier.

The process according to the invention can further comprise a step (v) of transporting the discharged metal particles to a sieving station 23 and/or to a bagging station. This step is preferably done simultaneously with the atomization step, with the cooling step and with the discharging step.

The discharged metal particles can be transported in the form of a fluidized bed 24. It is preferably a bubbling fluidized bed.

What is claimed is:

1-26. (canceled)

27. A process for manufacturing metal powders, the process comprising:
(i) feeding a chamber of a gas atomizer with molten metal;
(ii) atomizing the molten metal by injection of gas so as to form metal particles; and
(iii) cooling the metal particles in a lower section of the chamber by injecting gas from a bottom of the chamber so as to form a bubbling fluidized bed of metal particles.

28. The process as recited in claim 27 wherein the molten metal is steel obtained through a blast furnace route.

29. The process as recited in claim 27 wherein the molten metal is steel obtained through an electric arc furnace route.

30. The process as recited in claim 27 wherein steps (ii) and (iii) are done simultaneously.

31. The process as recited in claim 27 wherein, in step (iii), the metal particles are cooled below 300° C.

32. The process as recited in claim 27 wherein, in step (iii), the injected gas is extracted, cooled down and re-injected.

33. The process as recited in claim 32 wherein the gas is cooled down below 50° C.

34. The process as recited in claim 27 further comprising the step (iv) of continuously discharging metal particles from the chamber.

35. The process as recited in claim 34 wherein the continuous discharge is done through an overflow.

36. The process as recited in claim 34 further comprising the step (v) of transporting the discharged metal particles to a sieving station.

37. The process as recited in claim 36 wherein the discharged metal particles are transported in the form of a fluidized bed.

38. A gas atomizer comprising:
a chamber;
gas injectors positioned at a bottom of the chamber; and
a flow regulator coupled to the gas injectors for fluidizing the metal particles to be accumulated in a lower section of the chamber and forming a bubbling fluidized bed of metal particles.

39. The gas atomizer as recited in claim 38 wherein the gas injectors include openings in a bottom wall of the chamber.

40. The gas atomizer as recited in claim 39 wherein the distance between the bottom of the chamber and the gas injectors is shorter than 10 cm.

41. The gas atomizer as recited in claim 39 wherein the gas injectors are spargers.

42. The gas atomizer as recited in claim 39 further comprising a heat exchanger positioned in a lower section of the chamber.

43. The gas atomizer as recited in claim 39 further comprising an overflow in a lower section of the chamber.

44. The gas atomizer as recited in claim 43 wherein the overflow is a pipe at least partially extending in the lower section of the chamber and passing through a bottom wall of the chamber.

45. The gas atomizer as recited in claim 43 wherein a portion of the overflow outside the chamber includes a gas inlet.

46. The gas atomizer as recited in claim 39 further comprising a coarse particle collector at the bottom of the chamber.

47. The gas atomizer as recited in claim 39 further comprising a gas extractor in an upper section of the chamber.

48. The gas atomizer as recited in claim 47 wherein the gas extractor includes a cyclone separator for dedusting the gas extracted from the chamber.

49. The gas atomizer as recited in claim 47 wherein the gas extractor is connected to the gas injectors for gas recirculation within the atomizer.

50. The gas atomizer as recited in claim 49 wherein a connection between the gas extractor and the gas injectors includes a heat exchanger.

51. An installation comprising the gas atomizer as recited in claim 39 and a conveyor including a lower duct for circulation of gas, an upper duct for circulation of powder material and a porous wall separating the lower and upper ducts over an entire length.

52. The installation as recited in claim 51 wherein the lower duct of the conveyor includes a fluidization gas inlet and a flow regulator coupled to the gas inlet for fluidizing the metal particles to be discharged from the gas atomizer and forming a fluidized bed of metal particles in the upper duct.
